(19) United States
(12) Patent Application Publication
(10) Pub. No.: US 2026/0104141 A1
(43) Pub. Date: Apr. 16, 2026

(54) MOUNTING SYSTEM

(71) Applicant: Hubbell Incorporated, Shelton, CT (US)

(72) Inventors: Rodolfo Pepper Valdez, JR., San Antonio, TX (US); John Wesley Pearce, San Antonio, TX (US); Stephen Powell, Baltimore, MD (US); Christopher Jufer, Felton, PA (US); Timothy Ortel, Monkton, MD (US)

(21) Appl. No.: 19/357,573

(22) Filed: Oct. 14, 2025

Related U.S. Application Data
(60) Provisional application No. 63/706,939, filed on Oct. 14, 2024.
(60) Provisional application No. 63/898,592, filed on Oct. 14, 2025.

(51) Int. Cl. F16M 13/02; F16M 11/10; F16M 11/20; F16M 11/24

(52) U.S. Cl. CPC F16M 13/022; F16M 11/10; F16M 11/2021; F16M 11/2078; F16M 11/24; F16M 13/027

(57) ABSTRACT

A mounting assembly that includes a support bracket, a mounting bracket coupled to the support bracket, and a clamping mechanism coupled to the support bracket. The mounting bracket includes a bar, a first arm, a second arm, and a plate. The first arm is coupled between the bar and to the mounting bracket. The second arm is coupled between the bar and the mounting bracket. The plate is coupled to the bar and spaced apart from the first end and the second end. The clamping mechanism includes a first rail, a first clamp movably coupled to the first rail, a second rail, and a second clamp movably coupled to the second rail. The bar is pivotable about a first axis and the plate is pivotable about a second axis independent from the bar being pivotable about the first axis. The first and second rails are independently movable.

### CROSS-REFERENCE TO RELATED APPLICATIONS:

This application claims the benefit of U.S. Provisional Application No. 63/898,592, filed Oct. 14, 2025, and U.S. Provisional Application No. 63/706,939, filed Oct. 14, 2024, both of which are incorporated herein by reference in their entirety.

### FIELD:

The present disclosure relates to a mounting system. More particularly, the present disclosure relates to a mounting system for WiFi hardware.

### BACKGROUND

Wireless communications are prevalent throughout society. Access points (e.g., radios) are used to provide wireless communication, and antennas are used on the access points to transmit and receive data. The antennas used on access points are either internal or external antennas. Internal antennas are designed inside the access point and are inconspicuous to the users. External antennas are connected to the access port via coaxial cables and are seen by the users.

Hardware, like WiFi access points, may be mounted in various locations. When these access points are mounted to the ceiling or the wall, the antenna is mounted in as close proximity as possible to the access point. The cables and antenna can be bulky and not aesthetically pleasing to the owner of the structure (building) or users of the system. Because WiFi access points are manufactured by a variety of different manufacturers, there is no consistent size or shape across the different examples. Each access point may require its own unique mount or support. A need exists for a universal mount that can support hardware with a variety of different sizes and shapes.

Additionally, co-locating antennas and access points has been accomplished in the past by mounting an enclosure on the wall or a pole/mast. The enclosure has the access point (radio) mounted to a back plate inside the enclosure and the antenna mounted onto the door of the enclosure. This type of design does not provide the articulation for the antenna and can be big, bulky and heavy. Ceiling tile enclosures have been used to mount access points and external antennas, but the antennas do not have a way for them to be articulated. Current co-location mounts are fixed in nature, meaning the mount cannot be used in any other configuration and is typically limited to a single mounting method. A need therefore exists for a mount that co-locates an access point and an antenna to be able to pivot or rotate.

### SUMMARY

Various embodiments of the present disclosure can overcome various of the aforementioned and other disadvantages associated with known mounting systems and offer new advantages as well.

In some forms, there is provided universal mounting system.

In some forms, there is provided universal mounting system for WiFi hardware.

In some forms, there is provided a mounting system that includes a first element adjustable in a first direction and a second element adjustable in a second direction. The first element is adjustable independently of the second element.

In some forms, there is a mount for an access point (e.g., a radio) and an antenna.

In some forms, there is a mount for an access point (e.g., radio) and an antenna. The mount includes a base for attachment to a mounting structure, a base for attaching thereto an access point, and a tray attached to the base with a swivel mount.

In some forms, there is a modular mount where components can be used independently or in different configurations with other components.

In some forms, there is provided a mounting assembly that includes a support bracket, a mounting bracket coupled to the support bracket, and a clamping mechanism coupled to the support bracket. The support bracket can couple to a support. The mounting bracket includes a bar, a first arm, a second arm, and a plate. The bar extends between a first and second end. The first arm is coupled to the first end and to the mounting bracket. The second arm is coupled between the second end and the mounting bracket. The plate is coupled to the bar and spaced apart from the first end and the second end. The clamping mechanism includes a first rail, a first clamp, a second rail, and a second clamp. The first rail includes a first slot and a second slot. The first clamp is movably coupled to the first rail via the second slot. The second rail includes a third slot and a fourth slot. The second clamp is movably coupled to the second rail via the fourth slot. The bar is pivotable about a first axis relative to the first arm and the second arm. The plate is pivotable about a second axis relative to the bar and independent from the bar being pivotable about the first axis. The first rail is movably coupled to the second rail and can move independent of the second rail. The first clamp can move independently of the second clamp.

In some forms, there is a mounting assembly for mounting wireless communication hardware that includes a main chassis, an access point mounting assembly, a wireless access point, and a universal mounting bracket. The main chassis assembly includes a chassis base, a pair of chassis flanges extending from the chassis base, and a tray connected to the pair of chassis flanges and oriented parallel to the chassis base. The access point mounting assembly is connected to a first side of the chassis base between the pair of chassis flanges. The wireless access point is connected to the access point mounting assembly between the pair of chassis flanges. The universal mounting bracket is connected to a second side of the chassis base opposite to the access point mounting assembly. The universal mounting bracket includes a first set of mounting openings sized to connect to a first electrical box and a second set of mounting openings sized to connect to a second electrical box.

In some forms, there is provided a method of mounting WiFi access hardware. The method includes moving a first rail to a first position and a second rail to a second position to form a mounting space. The method also includes positioning the WiFi access hardware within the mounting space. The method further includes moving a first clamp relative to the first rail. The first clamp can contact a surface of the WiFi access hardware. The method additionally includes moving a second clamp relative to the second rail. The second clamp can contact the surface of the WiFi access hardware. The first clamp is movable independently of the second clamp.

The disclosure herein should become evident to a person of ordinary skill in the art given the following enabling description and drawings. The drawings are for illustration purposes only and are not drawn to scale unless otherwise indicated. The drawings are not intended to limit the scope of the invention. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred embodiments and reference to the accompany drawing wherein:

FIG. 1 is a perspective view of a mounting assembly.

FIG. 2 is an exploded view of the mounting assembly of FIG. 1.

FIG. 3 is a perspective view of an antenna mounting bracket of the mounting assembly of FIG. 1.

FIG. 4 is an exploded view of the antenna mounting bracket of FIG. 3.

FIG. 5 is a perspective view of the antenna mounting bracket of FIG. 3, pivoted about a first axis.

FIG. 6 is a perspective view of the antenna mounting bracket of FIG. 3, pivoted about a second axis.

FIG. 7 is a perspective view of an arm of the antenna mounting bracket of FIG. 3.

FIG. 8 is a perspective view of a bar of the antenna mounting bracket of FIG. 3.

FIG. 9 is a perspective view of a support of the antenna mounting bracket of FIG. 3.

FIG. 10 is a perspective view of a clamping mechanism of the mounting assembly of FIG. 1.

FIG. 11 is an exploded view of the clamping mechanism of FIG. 10.

FIG. 12 is a perspective view of the clamping mechanism of FIG. 10 with a cover removed illustrating rails in a first position.

FIG. 13 is a perspective view of the clamping mechanism of FIG. 10 with a cover removed illustrating rails in a second position.

FIG. 14 is a perspective view of a rail of the clamping mechanism of FIG. 10.

FIG. 15 is a perspective view of an arm assembly of the clamping mechanism of FIG. 10.

FIG. 16 is a detail exploded view of the arm assembly of the clamping mechanism of FIG. 10.

FIG. 17 is a perspective view of a clamp of the arm assembly of FIG. 15.

FIG. 18 is a perspective view of a frame of the arm assembly of FIG. 15.

FIG. 19 is a perspective view of a support mounting bracket of the mounting assembly of FIG. 1.

FIG. 20 is an exploded view of the support mounting bracket of FIG. 19.

FIG. 21 is a perspective view of a plate of the support mounting bracket of FIG. 19.

FIG. 22 is a first perspective view of the mounting assembly of FIG. 1 supporting wireless communications hardware.

FIG. 23 is a second perspective view of the mounting assembly of FIG. 1 supporting wireless communications hardware.

FIG. 24 is a perspective view of a mounting assembly supporting an antenna and an access point.

FIG. 25 is a perspective view of the mounting assembly of FIG. 24 without the antenna and the access point.

FIG. 26 is a perspective view of a chassis of the mounting assembly of FIG. 24.

FIG. 27 is a perspective view of a chassis base of the chassis of FIG. 26.

FIG. 28 is a perspective view of a flat flange of the chassis of FIG. 26.

FIG. 29 is a perspective view of a tray of the chassis of FIG. 26.

FIG. 30 is a perspective view of a universal mounting bracket of the mounting assembly of FIG. 24.

FIG. 31 is a bottom view of the universal mounting bracket of FIG. 30.

FIG. 32 is a perspective view of the universal mounting bracket of FIG. 30, coupled to a pipe mounting bracket.

FIG. 33 is a side view of the mounting assembly of FIG. 24 coupled to a cylindrical support via the pipe mounting bracket of FIG. 32.

FIG. 34 is a perspective view of the mounting assembly of FIG. 24 with an I-beam clamp.

FIG. 35 is a perspective view of the I-beam clamp.

FIG. 36 is a perspective view of an access point bracket assembly of the mounting assembly of FIG. 24.

FIGS. 37A and 37B are front and rear perspective views of L brackets of the access point bracket assembly of FIG. 36.

FIG. 38 is a perspective view of an access point mounting plate of the mounting assembly of FIG. 24.

FIG. 39 is a cross-sectional view of the mounting assembly of FIG. 24.

FIG. 40 is a perspective view of an antenna bracket of the mounting assembly of FIG. 40.

FIG. 41 is a side view of the antenna bracket of FIG. 40 coupled to an antenna.

FIG. 42 is a perspective view of the mounting bracket of FIG. 24 coupled to a pair of antennas.

### DETAILED DESCRIPTION:

Wireless communication hardware, like an access point and an antenna are typically deployed together. A colocation mount enables access points and antennas to be deployed in a variety of locations so that they can remain in close proximity to one another and reduce the components required to mount the devices.

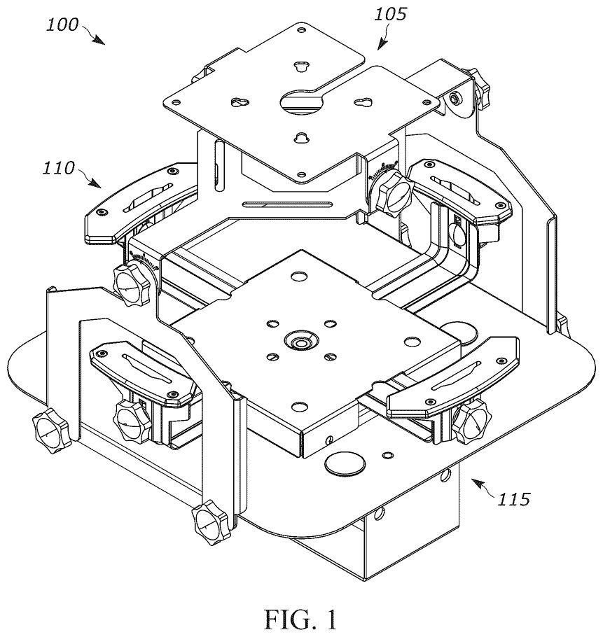

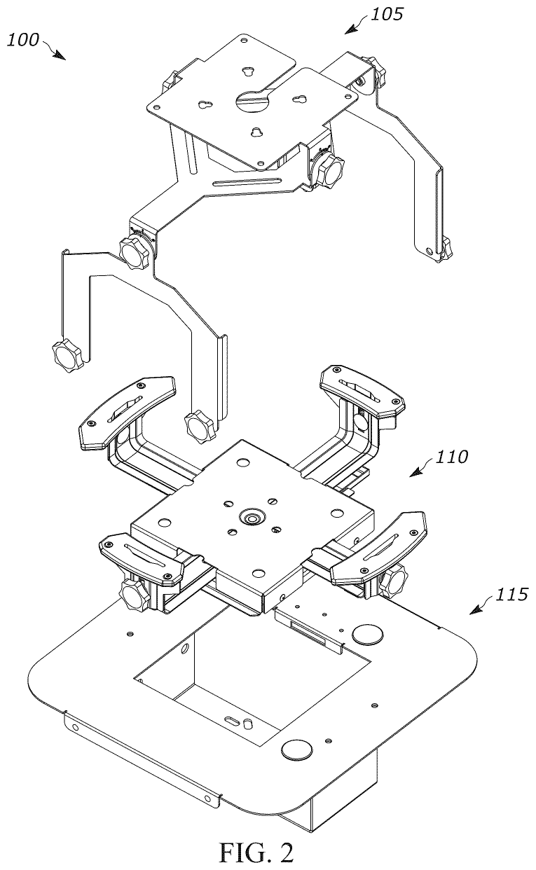

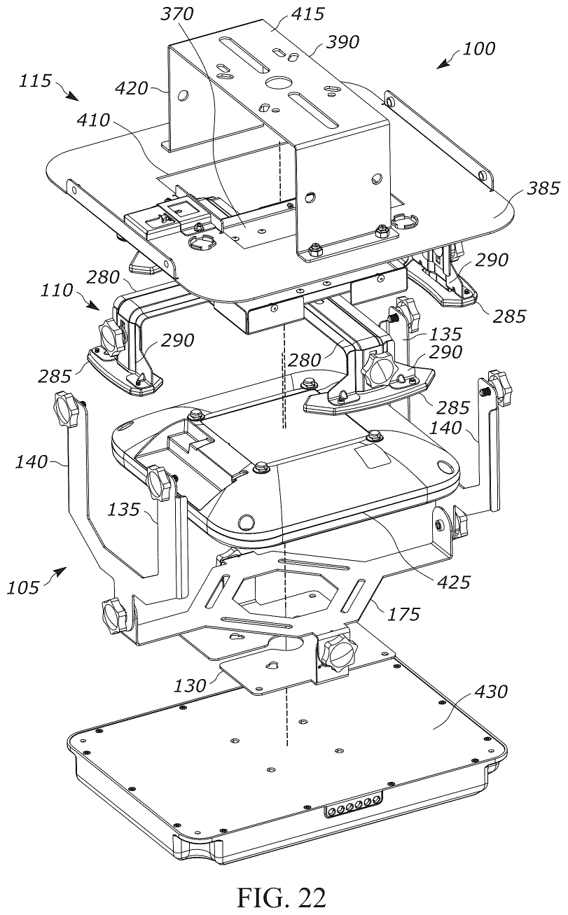

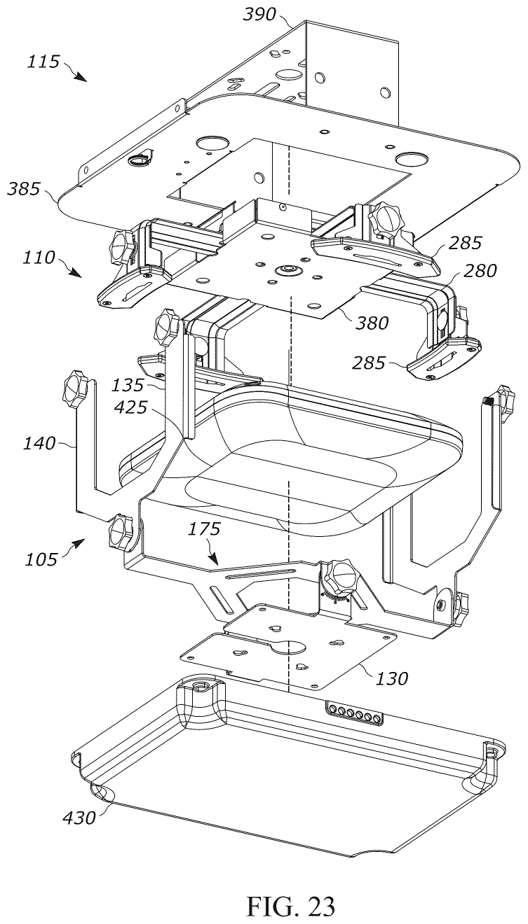

FIGS. 1 and 2 illustrate a first example of a mounting assembly 100 that can mount a device (e.g., collocate wireless communications hardware) to a support (e.g., a beam). The mounting assembly 100 may include an antenna mounting bracket 105, a clamping mechanism 110, and a support mounting bracket 115, which may be coupled together as described in more detail below. As described in more detail below, the antenna mounting bracket 105 and the clamping mechanism 110 may be used to connect to and collocate an antenna 430 and an access point 425 respectively (see e.g., FIGS. 22 and 23).

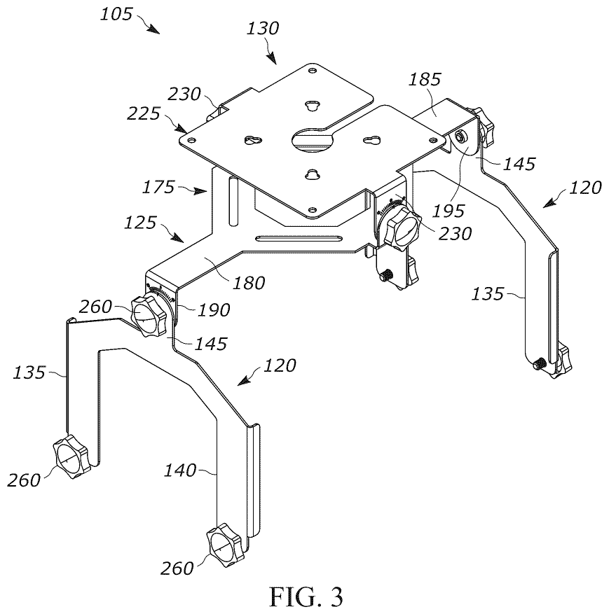

As shown in FIGS. 3 to 9, the antenna mounting bracket 105 may include a pair of arms 120, a bar 125, and a support or plate 130. As described in more detail below, these elements may be movably coupled together to permit various degrees of adjustment.

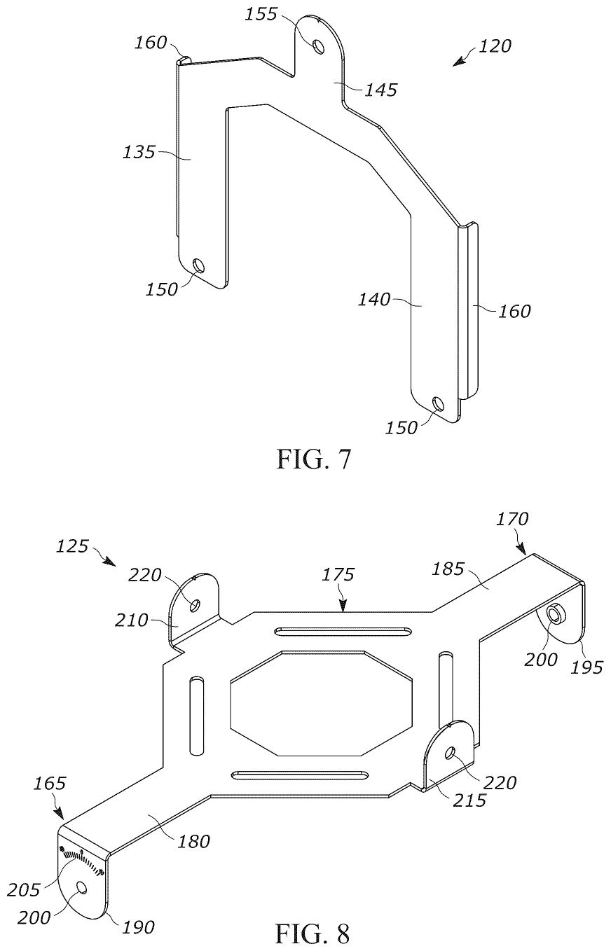

As shown in FIG. 7, an arm 120 may be substantially Y-shaped. For example, the arm 120 may include an elongated first segment 135 and an elongated second segment 140 spaced apart from the first segment 135. In the illustrated example, the first and second segments 135, 140 may be substantially parallel to one another and may be substantially the same length. However, the first segment 135 and/or the second segment 140 may have a different length and/or orientation in another example. The arm 120 may also include a third segment 145. The illustrated third segment 145 may be shorter than the first and second segments 135, 140, although it may be any length in other examples. The third segment 145 may also be parallel to the first and second segments 135, 140, although it may have a different orientation in other examples. Each of the first and second segments 135, 140 may be connected together to the third segment 145 (e.g., with an integral, one-piece connection).

In some forms, each of the first and second segments 135, 140 may include an aperture 150 at a free end of the respective segment 135, 140. A free end of the third segment 145 may also include an aperture 155. As described in more detail below, the apertures 150, 155 may receive a connector to connect the arm 120 to another body.

In some forms, each of the first and second segments 135, 140 may include a flange 160, which may extend at least partially along a length of the respective first and second segments 135, 140. For example, each flange 160 may extend along substantially the entire length of each respective segment 135, 140. However, one or more of the flanges 160 may extend a different length.

In certain forms, each flange 160 may be disposed on an outer edge of each respective segment 135, 140. Additionally, each of the flanges 160 may be bent in the same direction. For example, each flange 160 may be oriented approximately perpendicularly with respect to the segment 135, 140. In other examples, one or more of the flanges 160 may be positioned at a different location on the respective segment 135, 140 and/or may be bent in a different direction.

In some forms, the third segment 145 may be disposed approximately equally between the first and second segments 135, 140. However, the third segment 145 in other examples may be disposed closer to the first segment 135 or the second segment 140.

As shown in FIG. 8, a bar 125 may be an elongated member that extends between a first end 165 and a second end 170. A central section 175 may be disposed between the first and second ends 165, 170.

In the illustrated example, the central section 175 may be wider than the remainder of the bar 125. For example, the central section 175 may have a substantially hexagonal shape. However, other examples may include a different shape (e.g., circular, elliptical, triangular, rectangular, etc.). In still other examples, the central section 175 may have the same width as the remainder of the bar 125.

In some forms, a first extension 180 may extend from the central section 175 toward the first end 165 and a second extension 185 may extend from the central section 175 toward the second end 170. The illustrated first and second extensions 180, 185 may be substantially the same length, although the first extension 180 may be longer or shorter than the second extension 185 in other examples.

In some forms, a first tab 190 may be coupled to an end of the first extension 180 and a second tab 195 may be coupled to an end of the second extension 185. For example, the first tab 190 may be disposed at the first end 165 and the second tab 195 may be disposed at the second end 170.

In some forms, the first tab 190 may be substantially perpendicular to the first extension 180 and the second tab 195 may be substantially perpendicular to the second extension 185. However, other examples may include one or more of the tabs 190, 195 oriented at a different angle relative to the respective extension 180, 185.

In the illustrated example, each tab 190, 195 may include an aperture 200, which as described below, may receive a fastener. In certain forms, one or more of the tabs 190, 195 may include an indicium 205. In the illustrated example, the indicium 205 may be markings illustrating different angular positions. As described in more detail below, the indicium 205 may provide an indication to a technician.

In some forms, the bar 125 may further include a third tab 210 and a fourth tab 215 that extend from the central section 175. The third and fourth tabs 210, 215 may be substantially perpendicular to the central section 175. In the illustrated example, the third and fourth tabs 210, 215 may extend in the opposite direction from the first and second tabs 190, 195. Although one or more of the third and fourth tabs 210, 215 may extend in a different direction.

In some forms, the third tab 210 and the fourth tab 215 may each be oriented approximately 90 degrees between the first and second tabs 190, 195. However, the tabs 210, 215 may alternatively be oriented at any position.

In some forms, the third and fourth tabs 210, 215 may include an aperture 220, which as described below, may receive a fastener. The illustrated third and fourth tabs 210, 215 do not include indicia, however other examples of the tabs 210, 215 may include indicia (e.g., indications of different angular positions).

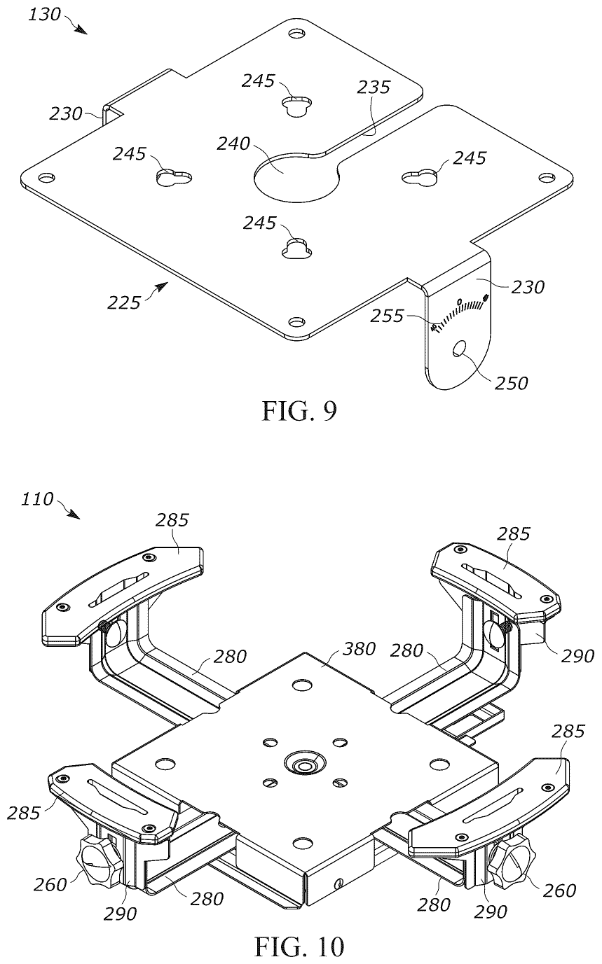

As shown in FIG. 9, the support 130 may include a body 225 and a pair of tabs 230 that extend from the body 225. In the illustrated example, the body 225 may have a substantially rectangular shape, although other examples may include another shape (e.g., circular, elliptical, etc.).

In some forms, the body 225 may include a slot 235 that extends from an edge toward an opening 240 in center of the body 225. One or more holes 245 may be formed through the body 225 and may be oriented around the opening 240. The illustrated example includes four holes 245, although other examples may include a different number of holes 245.

In some forms, the tabs 230 extend substantially perpendicularly with respect to the body 225 (although other examples may include one or more tabs 230 at another angle). The illustrated example also includes two tabs 230, disposed on opposing sides of the body 225. However, other examples may include a different number and/or a different orientation of the tabs 230.

In the illustrated example, each tab 230 may include an aperture 250, which as described below, may receive a fastener. In certain forms, one or more of the tabs 230 may include an indicium 255. In the illustrated example, the indicium 255 may be markings illustrating different angular positions. As described in more detail below, the indicium 255 may provide an indication to a technician.

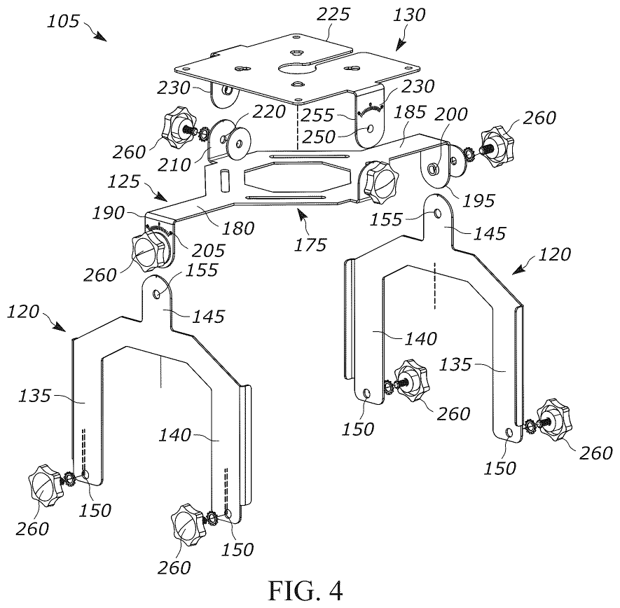

Returning to FIGS. 3 and 4, the arms 120, the bar 125, and the support 130 may be connected together to form the antenna mounting bracket 105. For example, the arms 120 may be directly coupled to the bar 125 and the support 130 may be directly coupled to the bar 125. In the illustrated example, each arm 120 may be coupled to the bar 125 separately from the support 130.

In some forms, the third segment 145 of each arm 120 may coupled to a respective one of the first and second tabs 190, 195. Specifically, the aperture 155 on each third segment 145 may be aligned with the aperture 200 on the respective first and second tabs 190, 195. In the illustrated example, each third segment 145 may be disposed on an outer face of the respective first and second tab 190, 195. However, the third segment 145 of either arm 120 may be disposed on an inner surface of the respective tab 190, 195 in other examples. A fastener 260 may be inserted through the aligned apertures to connect each arm 120 to the bar 125.

In some forms, the tabs 230 of the support 130 may be aligned with the third and fourth tabs 210, 215 of the bar 125. More specifically, the aperture 250 of each tab 230 may be aligned with the aperture 220 of the respective third and fourth tabs 210, 215. In the illustrated example, the tabs 230 of the support 130 may be disposed against an inner surface of the respective third and fourth tabs 210, 215. However, the tabs 230 may be disposed on an outer surface of the respective tab 210, 215 in other examples. A fastener 260 may be inserted through the aligned apertures to connect each arm 120 to the bar 125.

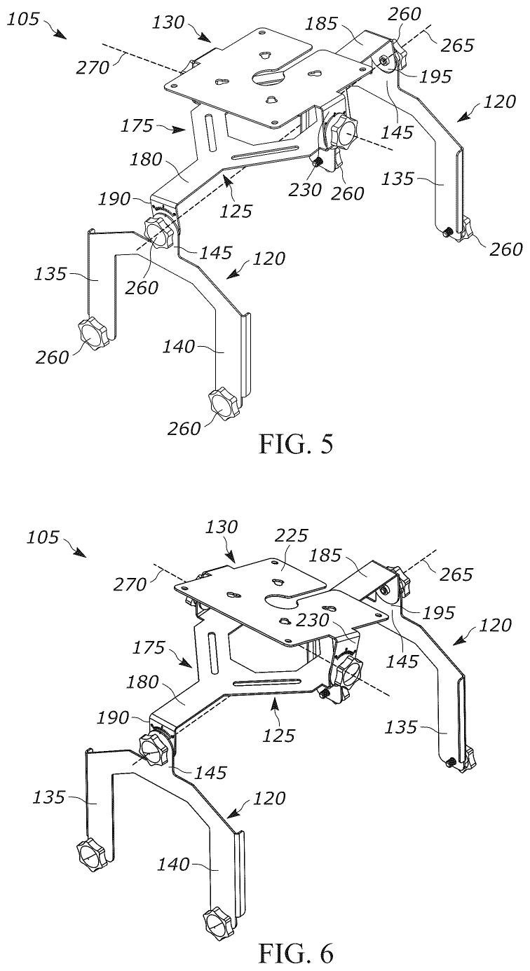

As shown in FIGS. 5 and 6, the antenna mounting bracket 105 may be adjustable about a first axis 265 and about a second axis 270. In the illustrated example, the first axis 265 is perpendicular to the second axis 270.

In some forms, the first axis 265 may extend between the first and second ends 165, 170. More specifically, the first axis 265 may pass through the apertures 200 on the first and second tabs 190, 195. As shown in FIG. 5, the bar 125 may pivot relative to the arms 120 about the first axis 265. A technician may observe the angle of rotation using the indicia 205 on the tabs 190, 195. The support 130 may rotate with the bar 125 relative to the arms 120.

In some forms, the second axis 270 may extend between the third and fourth tabs 210, 215. More specifically, the second axis 270 may extend through the apertures 250. As shown in FIG. 6, the support 130 may pivot relative to the bar 125 about the second axis 270. A technician may observe the angle of rotation using the indicia 255 on the tabs 210, 215. The arms 120 and the bar 125 may remain rotationally fixed when the support 130 pivots about the second axis 270.

In the illustrated example, pivoting movement by the bar 125 about the first axis 265 may be independent of pivoting movement of the support 130 about the second axis 270. A technician may loosen any of the fasteners 260 to pivot the bodies connected by the respective fasteners 260, and then tighten the fasteners 260 to retain the bodies in the desired position. In other example, the fasteners 260 may be replaced by other fasteners (e.g., a rachet mechanism) so that the bodies are movable between discrete positions.

As shown in FIGS. 10 to 18, a clamping mechanism 110 can include rails 280, clamps 285, and frames 290. As described in more detail below, these elements may be movably coupled together to permit various degrees of adjustment.

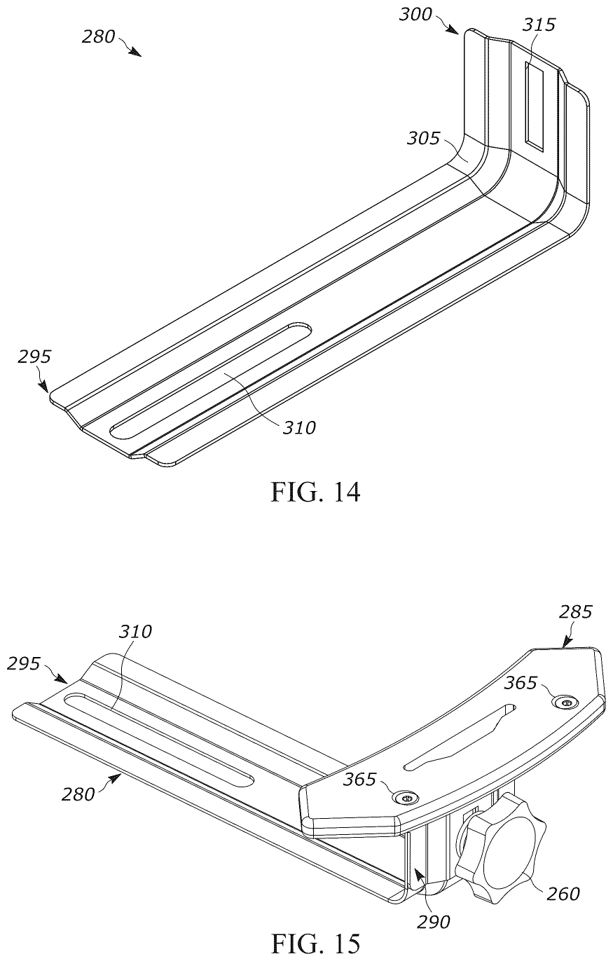

As shown in FIG. 14, the rail 280 may be formed as an elongated member that includes a first end 295 and a second end 300. In the illustrated example, the rail 280 may include a bend 305 along a portion of its length so that an entire length along a surface of the rail 280 is not in the same plane. In the illustrated example, the bend 305 may be formed at substantially a right angle and the bend 305 may be formed closer to the second end 300. In other examples, the bend 305 may be formed at a different angle and/or the bend 305 may be formed at a different position along the length of the rail 280 (e.g., proximate to the first end or in the middle between the first and second ends 295, 300).

In some forms, the rail 280 may include a first slot 310 and a second slot 315. The first slot 310 may be disposed proximate to the first end 295 and the second slot 315 may be disposed proximate to the second end 300. In the illustrated example, the first slot 310 is longer than the second slot 315. However, the first slot 310 may be equal to or shorter than the second slot 315 in other examples.

As shown in FIGS. 15 to 18, a fastening system consisting of a clamp 285 and a frame 290 can be coupled to a rail 280. As described in more detail below, the clamp 285 and the frame 290 may be movably coupled to the rail 280 to provide a clamping force.

As shown in FIG. 17, the clamp 285 may include a body 320 with at least one fastening hole 325 (e.g., two shown) passing through the body 320. The body 320 may also include a body slot 330 disposed between the fastening holes 325.

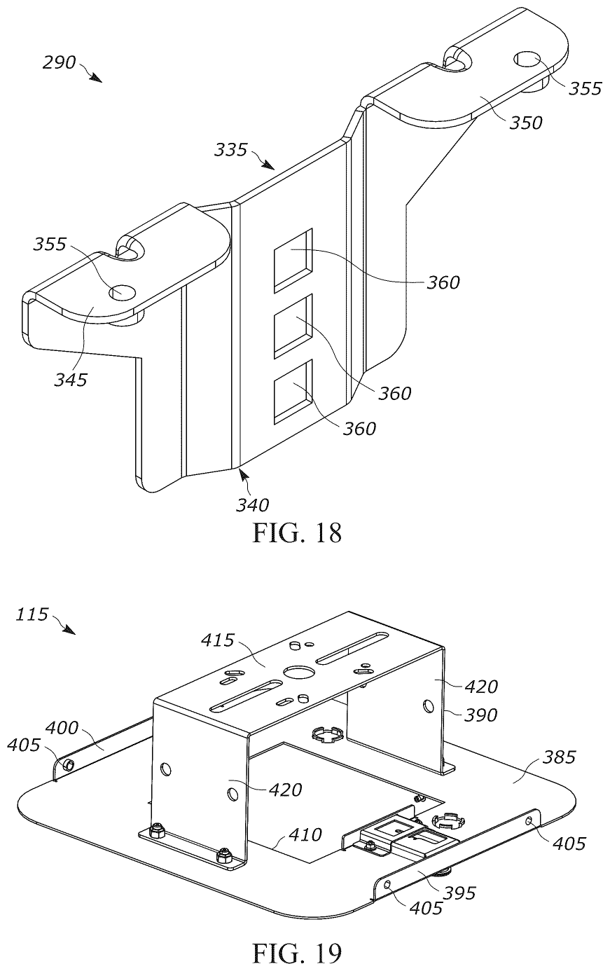

As shown in FIG. 18, the frame 290 includes an upper end 335 and a lower end 340. The upper end 335 may include a first tab 345 and a second tab 350 spaced apart from the first tab 345. In the illustrated example, the first tab 345 and the second tab 350 each include a hole 355.

The frame 290 may also include at least one opening 360 (e.g., three shown). The openings 360 may be aligned along a vertical direction between the upper and lower ends 335, 340. The illustrated openings 360 include a substantially rectangular shape, although at least one of the openings 360 can include a different shape (e.g., circular, elliptical, etc.).

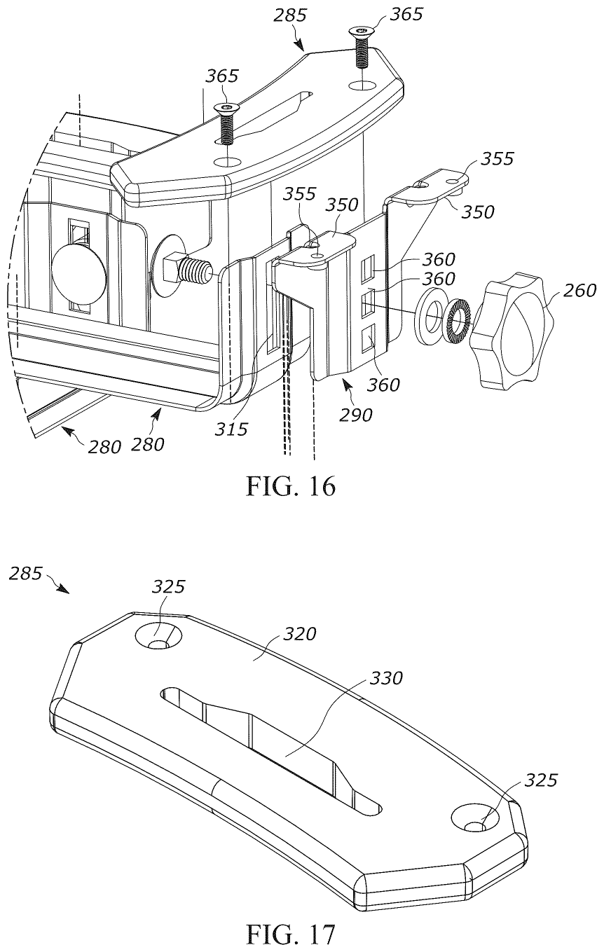

Returning to FIGS. 15 and 16, a fastener 365 (e.g., a threaded screw) may be used to couple the clamp 285 to the frame 290. For example, the clamp 285 may be positioned against the tabs 345, 350 so that the holes 355 are aligned with the fastening holes 325. A fastener 365 can then be inserted into each aligned hole 355 and fastening hole 325 to secure the clamp 285 to the frame 290.

With continued reference to FIGS. 15 and 16, the frame 290 can also be connected to the rail 280. The rail 280 may be positioned so that the openings 360 are proximate to the second slot 315. A fastener 260 may be inserted through the second slot 315 into one of the openings 360 to secure the frame 290 to the rail 280. As described in more detail below, a technician may select a different opening 360 to insert the fastener 260 through to change a height of the clamp 285.

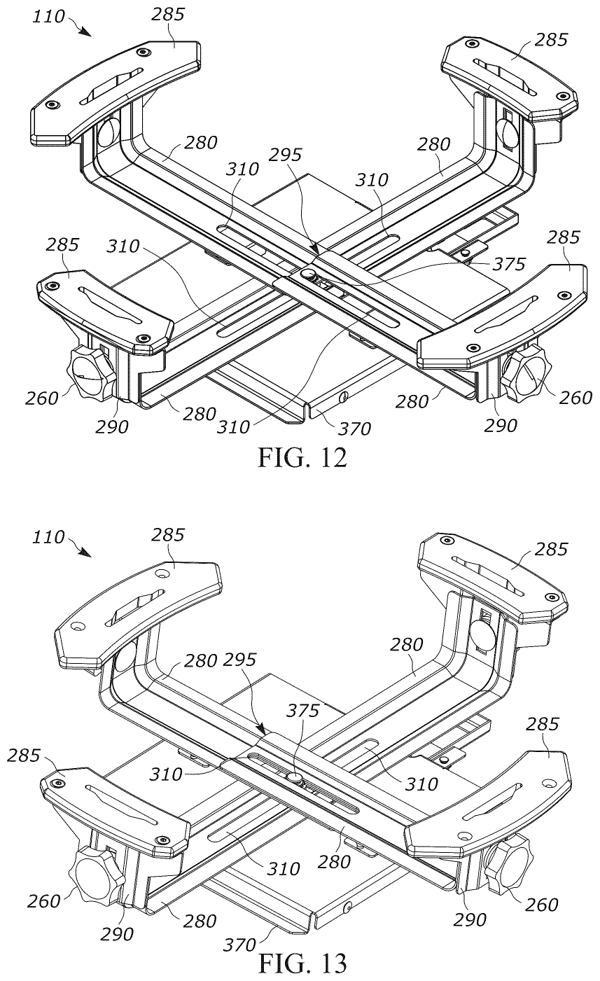

Returning to FIGS. 12 and 13, the illustrated clamping mechanism 110 can include four rails 280, each connected to a frame 290 and a clamp 285. Other examples may include a different number of rails 280. A height of the frame 290 and clamp 285 on each rail 280 may be independently adjustable relative to the clamps 285 and frames 290 coupled to the other rails 280.

In some forms, the rails 280 may be connected to a mounting plate 370. In the illustrated example, the rails 280 may be oriented so that the first slot 310 of each rail 280 is at least partially aligned with the first slots 310 of the other rails 280. More specifically, the four illustrated rails 280 may be oriented approximately 90 degrees apart from the two adjacent rails 280. A single fastener 375 may be inserted through the mounting plate 370 and each of the first slots 310 to couple the rails 280 to the mounting plate 370. In other examples, the rails 280 may be connected to the mounting plate 370 in a different manner (e.g., at different angles, with a different number of fasteners, etc.).

In some forms, the rails 280 may be able to move (e.g., translate) relative to one another to change a spacing between the second ends 300 of the different rails 280. For example, the rails 280 may being in a first position as illustrated in FIG. 12, which may represent a maximum distance between the various second ends 300. In this position, the fastener 375 is disposed at an end of each first slot 310 proximate to the first end 295 of the respective rail 280.

As illustrated in FIG. 13, one or more of the rails 280 may move to alter the spacing between the second ends 300. For example, one or more rails 280 may translate (e.g., slide) so that the second end 300 of the one rail 280 moves closer to the second end 300 of the opposite rail 280. In this position, the fastener 375 may be disposed closer to the second end 300 of the moving rail 280 than in the first position. To permit the movement of the rails 280, the fastener 375 may be loosened, and then tightened when the rails 280 have been moved to a desired location.

In some forms, each of the rails 280 may be independently translatable relative to the other rails 280. In other examples, the movement of one or more rails 280 may directly impact the position of one or more other rails 280. For example, opposing rails 280 may be connected by a track so that the two opposite rails 280 move together.

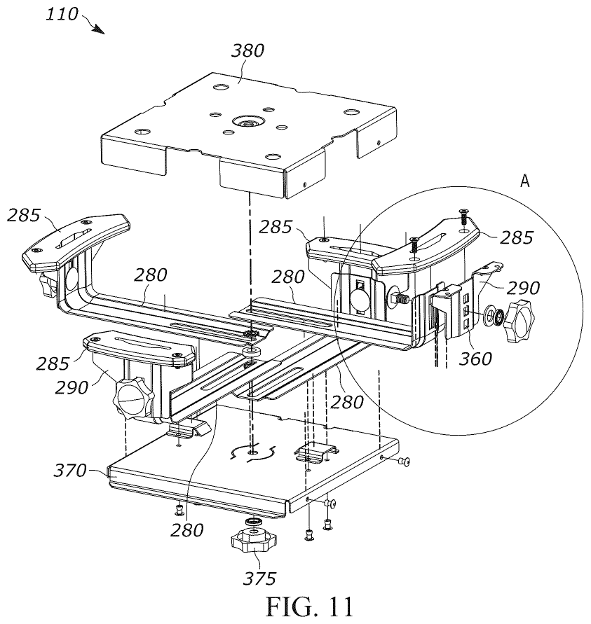

As shown in FIGS. 10 and 11, a cover 380 may be disposed over the mounting plate 370 to at least partially sandwich the rails 280 between the mounting plate 370 and the cover 380. The cover 380 may include a substantially planar surface.

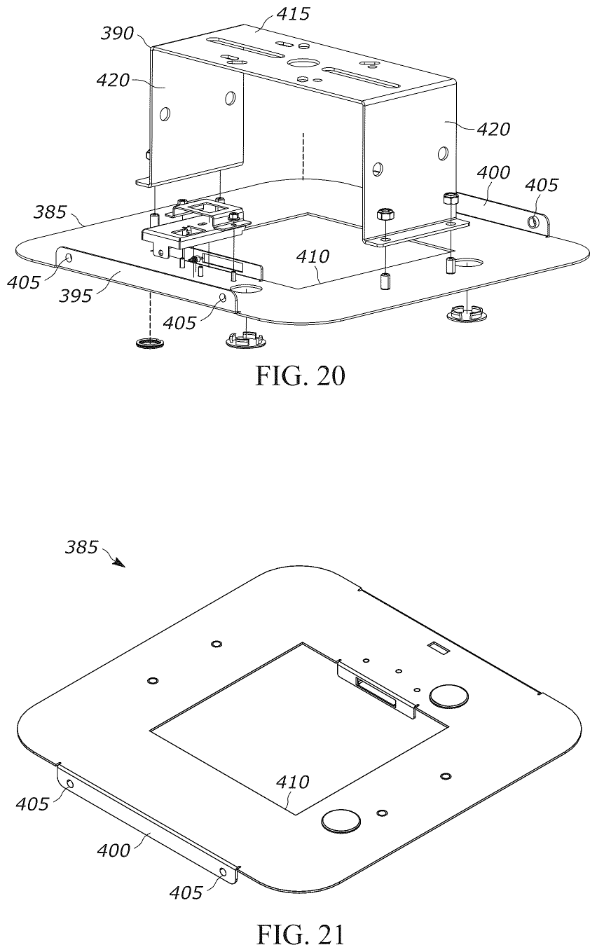

As shown in FIGS. 19 to 21, the support mounting bracket 115 may include a base 385 and a brace 390 coupled to the base 385. In the illustrated example, the base 385 may include a first flange 395 and a second flange 400 disposed on an opposite side of the base 385 from the first flange 395. Each of the flanges 395, 400 may include mounting apertures 405.

In the illustrated example, each of the flanges 395, 400 may be oriented approximately perpendicular with respect to the body of the base 385. Additionally, both flanges 395, 400 may be oriented in the same direction. In other examples, at least one of the flanges 395, 400 may be oriented at a different angle and/or in a different direction.

In some forms, an opening 410 may be disposed in a center of the base 385. For example, the opening 410 may be disposed between the first and second flanges 395, 400. The illustrated opening may be substantially rectangular, although the opening 410 may have any shape in other examples (e.g., circular, elliptical, etc.).

In some forms, the brace 390 may be coupled to the base 385 radially outside of the opening 410 and offset from the flanges 395, 400. For example, a connection between the brace 390 and the base 385 may be approximately 90 degrees from the flanges 395, 400.

In some forms, the brace 390 may include a first segment 415 that is spaced apart from and substantially parallel to the surface of the base 385. A second segment 420 may be coupled to either end of the first segment 415. The illustrated second segments 420 may be substantially perpendicular to the first segment 415, although one or more of the second segments 420 can be disposed at a different position.

Returning to FIGS. 1 and 2, the base 385 may be connected to the antenna mounting bracket 105. For example, the first and second segments 135, 140 of each arm 120 may be disposed proximate to one of the flanges 395, 400 of the base 385. Specifically, the aperture 150 on each segment 135, 140 may be aligned with one of the apertures 405 on the respective flange 395, 400. A fastener 260 may be inserted through the aligned apertures 150, 405 to connect the antenna mounting bracket 105 to the support mounting bracket 115.

The base 385 may also connect to the clamping mechanism 110. For example, the opening 410 of the base 385 may be sized and shaped to receive the mounting plate 370.

In some forms, the antenna mounting bracket 105 and the clamping mechanism 110 may extend in a first direction from the base 385. The brace 390 may extend in the opposite direction from the base 385.

As shown in FIGS. 22 and 23, the mounting assembly 100 may be used to retain various types of hardware. The figures specifically illustrate hardware for providing a WiFi signal, although other examples may include different types of hardware.

For example, a WiFi access point 425 may not come in a standard size and may come in different shapes and sizes depending on the specific manufacturer. Different elements of the mounting assembly 100 may be able to move to accommodate WiFi access points 425 of various shapes and sizes so that the mounting assembly 100 may be usable with a variety of devices.

In some forms, the WiFi access point 425 may be received between the antenna mounting bracket 105 and a clamping mechanism 110. More specifically, the WiFi access point 425 may be received in the space between the rails 280. As described above, the rails 280 may move relative to the fastener 375 to expand or contact the space between the rails 280. In the illustrated example, each rail 280 may be independently adjustable relative to the other rails 280. A technician may adjust the position of any one of the rails 280 based on a size of the WiFi access point 425.

In some forms, the WiFi access point 425 may be secured within the space by the clamps 285, which may contact a surface of the WiFi access point 425 to retain it against the rails 280. The position of each clamp 285 may be independently adjustable relative to the other clamps 285 to accommodate WiFi access points 425 with different sizes. For example, the frame 290 connected to each clamp 285 may receive a fastener 260 through an opening 360 selected for the specific WiFi access point 425. In other words, a technician may raise or lower the clamp 285 may inserting the fastener 260 through a different opening 360, to thereby provide a different camping force tailored for the specific WiFi access point 425. In other examples, the frame 290 may be slidably adjustable to an infinite number of locations.

With continued reference to FIGS. 22 and 23, an antenna 430 may be coupled to the antenna mounting bracket 105. For example, the support 130 may include a planar surface that can couple to the antenna 430. The various features on the support 130 (e.g., the slot 235, the opening 240, and/or the holes 245) may provide a variety of connection options for different types of antennas 430.

In some forms, the antenna mounting bracket 105 may move to provide adjustment for the antenna 430. For example, the antenna mounting bracket 105 may pivot about the first and/or second axes 265, 270 to adjust a position of the antenna 430. As described above, rotation about the first axis 265 may be independent of rotation about the second axis 270.

In some forms, the support mounting bracket 115 may connect the mounting assembly 100 to a support (not shown). In some forms, the brace 390 may be sized and shaped to couple to a support and support the mounting assembly 100 in a fixed position.

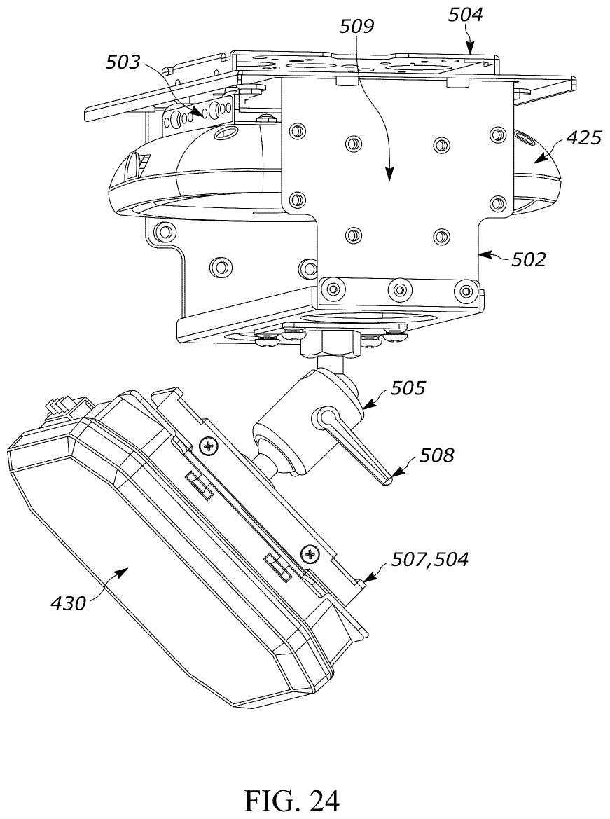

FIGS. 24 to 42 illustrate a second example of a mounting assembly 500 that may be similarly used to collocate wireless communications hardware (e.g., an access point and an antenna). The mounting assembly 500 may have some similarities and differences with the mounting assembly 100.

As shown in FIG. 24, a mounting assembly 500 can include a main chassis 502 and an antenna bracket 507 that can be used to support an access point 425 and an antenna 430 respectively. The mounting assembly 500 may be used as a universal mounting assembly to support access points 425 and/or antennas 430 of different shapes and/or sizes. Additionally, the mounting assembly 500 may be used in a variety of deployment sites to enable the access point 425 and antenna 430 to be mounted in a variety of different locations.

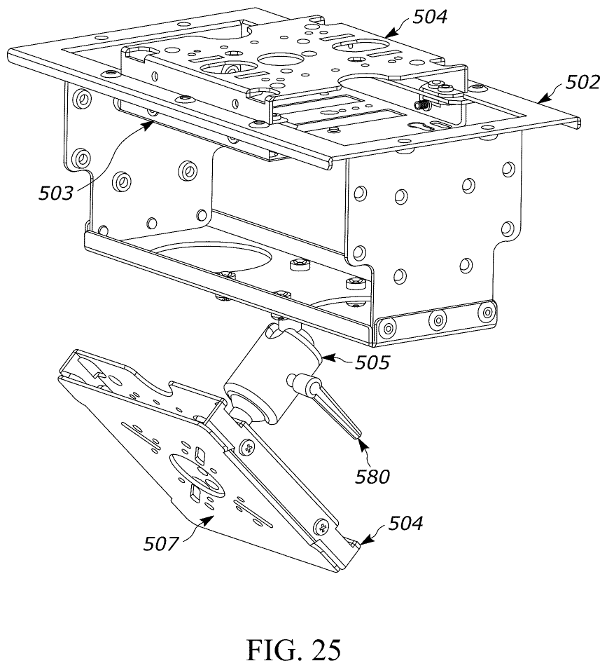

As shown in FIG. 25, the main chassis 502 of the mounting assembly 500 may include a universal mounting bracket 504 with an access point bracket assembly 503. The main chassis assembly 502 may be created from a rigid material (e.g., sheet metal) that is connected to form the three-dimensional structure of the main chassis assembly 502. In other examples, the main chassis assembly 502 may be integrally formed from a single piece of material.

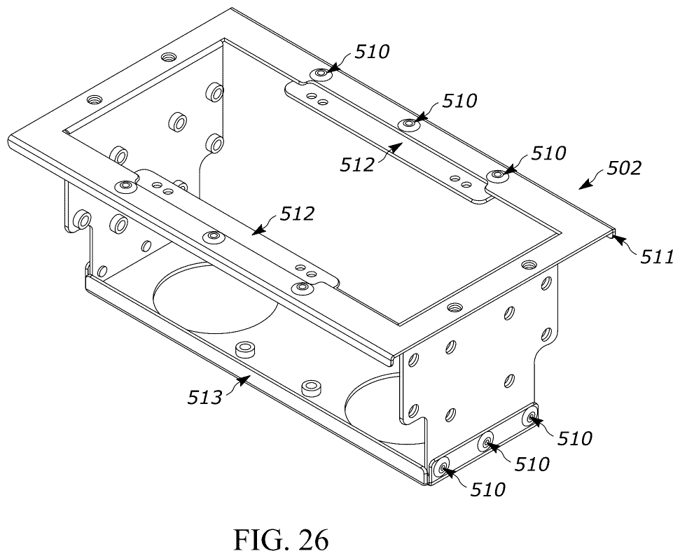

As shown in FIG. 26, the main chassis assembly 502 may be formed from sheet metal parts that are connected with fasteners 10 (e.g., rivets). The main chassis assembly 502 may be formed with one or more cross-sections having a substantially rectangular shape. For example, each side of the illustrated chassis assembly 502 may be substantially rectangular. However, other examples of the chassis assembly 502 may have a different shape.

In some forms, the main chassis 502 may be formed from a main chassis base 511, a tray 513, and a pair of side walls or flanges 515. The main chassis base 511 may be oriented parallel to the tray 513 and may be spaced apart from the tray 513 by the distance of the flanges 515.

In certain forms, there may be no additionally side walls that are perpendicular to the flanges 515 and extend between the main chassis base 511 and the tray 513. In other words, the main chassis assembly 502 may be open across its width in one direction.

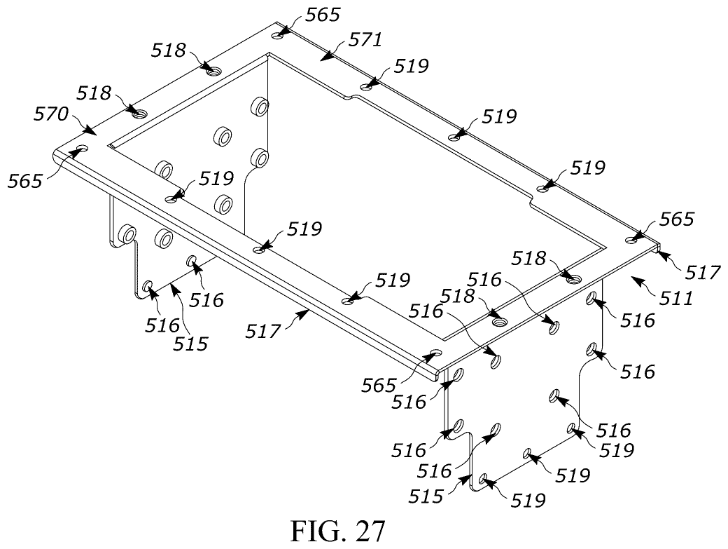

As shown in FIG. 27, the flanges 515 may be formed substantially perpendicularly with respect to an upper surface 570 of the chassis base 511 (although other examples may include the flanges 515 formed at other angles). In the illustrated example, the flanges 515 may be integrally formed with the upper surface 570. More specifically, each flange 515 may be formed as a cantilever member whose free end was cut from a center of the upper surface 570. Each flange 515 may be bent around its fixed end to a position substantially perpendicular to the upper surface 570. In other examples, the flanges 515 may be separate pieces that are connected to the upper surface 570 (e.g., via fasteners, welding, etc.). An opening 571 may remain in a center of the upper surface 570 in the shape of the flanges 515.

In some forms, each flange 515 may include fastening portions 516 (e.g., PEM nuts) that can be used to connect additional elements to the mounting assembly 500. As described in more detail below, articulating mounts and/or arm mounts for antennas or access points may be connected to either flange 515 via the fastening portions 516. The fastening portions 516 may be arranged in a pattern that can accommodate different types and/or sizes of mounts.

One or more flanges 517 (e.g., two shown) may bend downward from the outer edges to give the upper surface 570 increased rigidity. In the illustrated example, each flange 517 may be formed on an outer edge of the upper surface 570 (e.g., outside of the opening 571). The flanges 517 may also extend along a respective edge of the upper surface 570 that is perpendicular to the edge along which either flange 515 is connected.

In some forms, the upper surface 570 may also include one or more fastening portions 518 (e.g., PEM nuts), which can be used for attaching an I-beam mounting bracket. In the illustrated example, the fastening portions 518 are disposed at an end of the upper surface 570 proximate to the flanges 515. The illustrated example may also include a pair of fastening portions 518 on either side of the upper surface 570, although other configurations may be used. In some examples, the fastening portions 518 may be the same type as the fastening portions 516, although other examples may include different types.

In some forms, there may be rivet clearance holes 519 (e.g., six shown) for attaching a pair of flat flanges 512 (see e.g., FIGS. 3 and 5). The illustrated rivet clearance holes 519 may be disposed proximate to edges of the upper surface 570 perpendicular to edges where the fastening portions 518 are located. For example, the rivet clearance holes 519 may be disposed proximate to the flanges 517.

Rivet holes 519 may also be formed proximate to a free end of each flange 515. These rivet holes 519 may be used to attach each flange 515 to the articulating mount tray 513.

In some forms, corner clearance holes 565 may be formed in one or more corners of the upper surface 570. For example, the corner clearance holes 565 may be formed between the fastening portions 518 and the rivet clearance holes 519. The corner clearance holes 565 may be used to mount the chassis directly to a support surface (e.g., a wall).

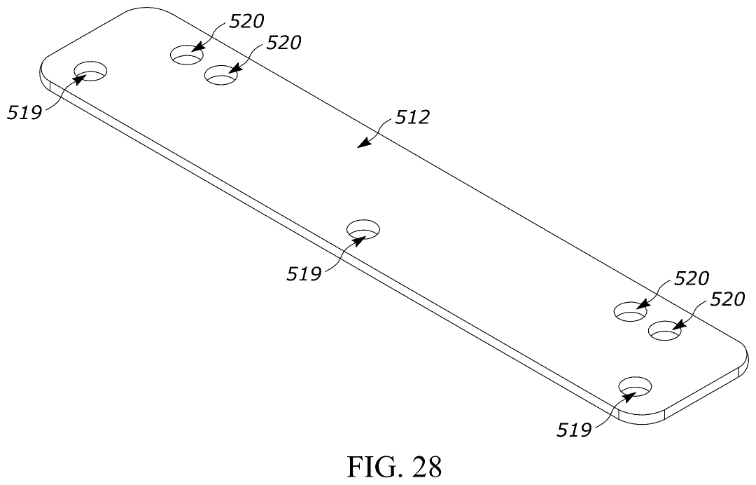

Connection between the flat flanges 512 and the upper surface 570 may form a flange surface for attaching the universal mounting bracket 504 to the access point bracket 503. As shown in FIG. 28, each flat flange 512 may have a substantially rectangular shape. However, other examples may have a different shape.

In some forms, the flat flange 512 may include spaced apart rivet holes 519 that may match up to the rivet holes 519 on the upper surface 570 to enable a fastener to extend through the aligned holes 519 and connect each flat flange 512 to the upper surface 570. The flat flange 512 may also include clearance holes 520 (e.g., two pairs of clearance holes 520). These may be positioned proximate to an opposite edge of the flat flange 512 than the rivet holes 519.

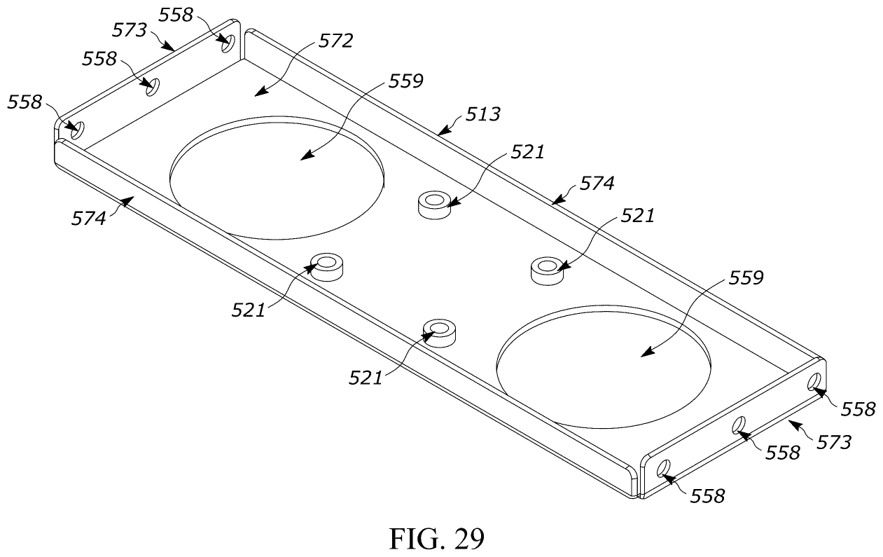

As shown in FIG. 29, the articulating mount tray 513 may include a lower surface 572 that has a substantially rectangular shape (although it may be any other shape). A pair of end flanges 573 and a pair of side flanges 574 may extend from the lower surface 572. The flanges 573, 574 may also have a rectangular shape and may be integrally formed with the lower surface 572. However, one or more of the flanges 573, 574 may be formed as a different shape and/or formed separately from and connected to the lower surface 572.

In some forms, each end flange 573 may include one or more clearance holes 558 (e.g., three shown on each end flange 573). The clearance holes 558 may be sized and spaced to align with the rivet holes 519 at the free end of the side flanges 515 so that fasteners can be inserted through each pair of aligned holes 519, 558 to connect the articulating mount tray 513 to the chassis base 511. For example, rivets 510 (see e.g., FIG. 26) may be used to connect the articulating mount tray 513 to the chassis base 511.

In some forms, the lower surface 572 of the tray 513 may contain fastening members 521 (e.g., PEM nuts) that enable the attachment of additional components (e.g., an articulating mount 505 as shown in FIG. 25). A pair of cutouts 559 (e.g., circular cutouts) are present in the lower surface 572 of the tray 513 to allow for cable routing from the access points or antennas mounted on either side of the lower surface 572. In the illustrated example, the fastening members 521 may be disposed between the cutouts 559.

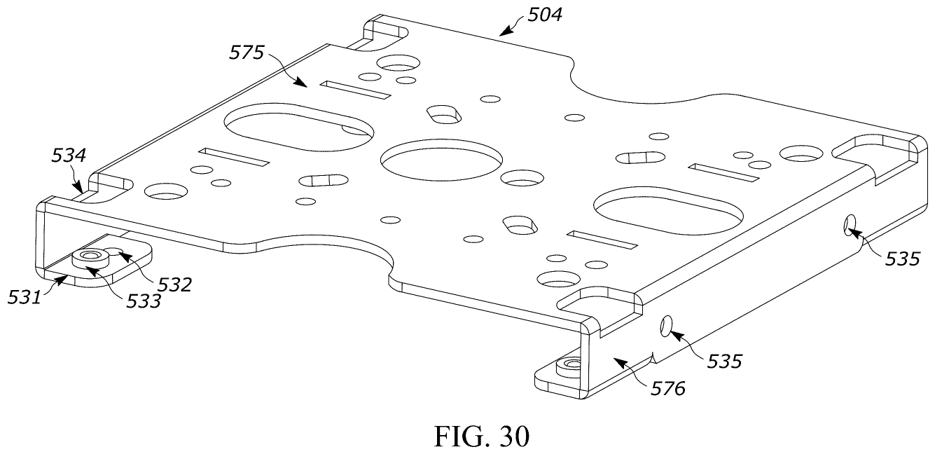

FIGS. 30 to 32 illustrate a modular universal mounting bracket 504, to enable the mount assembly 500 to be mounted in a variety of ways on deployment sites. The universal mounting bracket 504 may also be designed to work with specially purposed interchangeable brackets that contain hole patterns for specific uses.

As shown in FIG. 30, universal mounting bracket 504 may be formed similarly to a “hat bracket. ” The mounting bracket 504 may have a first or top surface 575 formed with a substantially rectangular shape (although any shape may be used). Side walls 576 may extend away from the top surface 575 in a substantially perpendicular orientation. The height of each wall 576 may be less than a length of the top surface 575. Flanges 531 may be located at the corners of the walls 576 and bent inward to minimize the overall footprint of the bracket 504. The “hat bracket” style may also allow the main face of the bracket 504 to be spaced apart from the surface of from which it mounts to. In some cases, fastener hardware needs to have space underneath a face of the bracket 504, such as nuts for mounting to all-thread, conduit, and screws and nuts.

The bent flanges 531 may allow the bracket 504 to mount against other brackets or surfaces. In some forms, each flange 531 has a clearance hole 532 and/or a fastener 533 (e.g., a PEM nut), which can give a user a flexibility for which side they can install screws. The clearance hole 532 may receive a screw that can be inserted from above the flange 531 to thread into either another surface (like during wall/ceiling mounting), or it can receive a hex nut/PEM nut to attach to another bracket. The fastener 533 may permit a screw to be inserted in from below the universal articulating bracket 504. Depending on the use case, it may be more convenient to install a screw from one side versus the other. Screw access cutouts 534 are located directly above each flange 531 to allow a screw and screwdriver to pass through to fasten the screw.

In some forms, a pair of side screw clearance holes 535 may be located on each of the walls 576 of the bracket 504 and can be used to attach antenna brackets 507. Because many devices like access points 425 and antennas 430 are larger than the universal mounting bracket 504 removing screws from the sides may be easier when access to the back of the device is blocked by the universal mounting bracket 504. This way a device can be removed without disassembling the entire assembly.

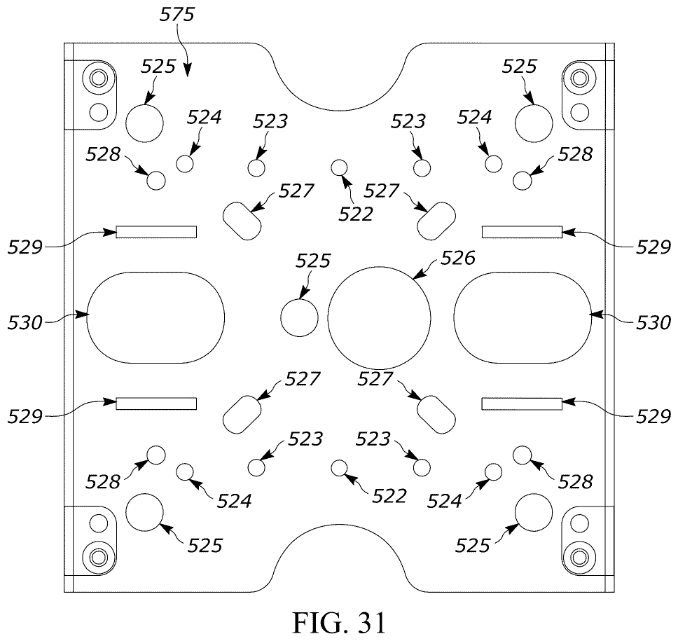

As shown in FIG. 31, the top surface 575 may include a variety of different openings that can be used to connect to different elements and/or surfaces. The openings may have different shapes and/or sizes and may be disposed in different patterns so that the bracket 504 can connect to these different elements without further modification (e.g., making it universally usable). For example, the top surface 575 may include first openings 522 (e.g., for use with a single gang junction box), second openings 523 (e.g., for use with a double gang junction box or a 4″ junction box), third holes 525 (e.g., for use with an all-thread rod to permit hanging), and a fourth hole 526. The third holes 525 may be arranged in a square pattern (e.g., one hole at each corner) and a central hole. A single length of all-thread rod (not shown) may be connected to the central third hole 525, and the additional third holes 525 may be used for additional balancing. The square pattern of the third holes 525 can also be employed to mount directly to walls or ceiling using larger fasteners. The fourth hole 526 may be located in the center to allow the bracket 504 to hang from lengths of electrical conduit.

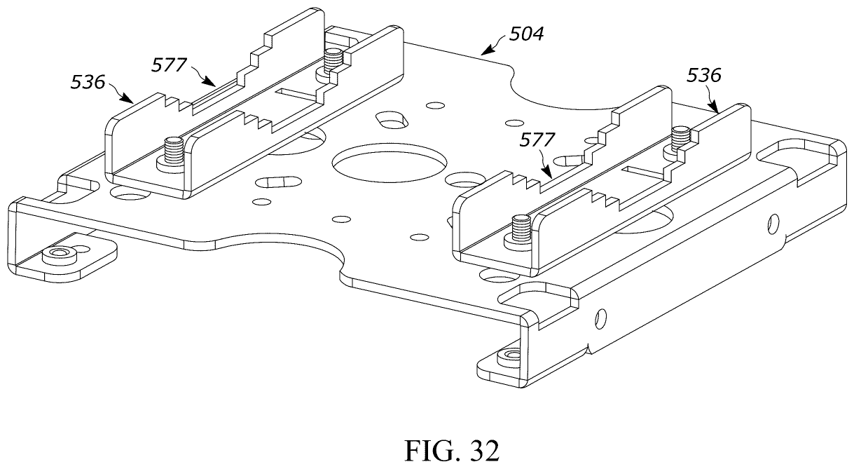

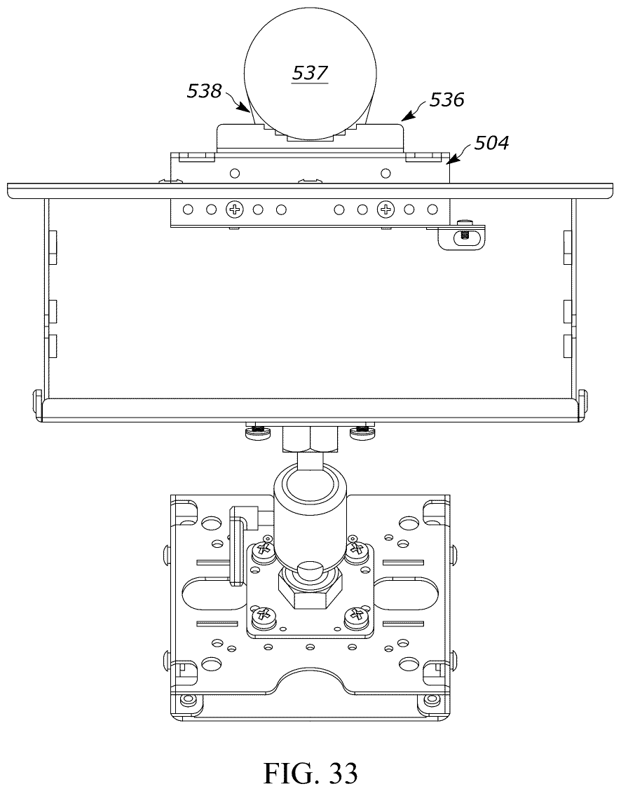

In some forms, the top surface 575 may include fifth holes 528, which can be arranged in a rectangular pattern. A pair of slots 529 may be arranged between a pair of fifth holes 528. As shown in FIGS. 32 and 33, pipe mounting brackets 536 may be coupled to the top surface 575 of the bracket 504 via the fifth holes 528. Each pipe mounting bracket 536 may include slots that are aligned with the slots 529 when connected to the bracket 504. The pipe mounting bracket 536 may also include a channel 577 in a center of the bracket 536, which may be disposed in between the slots of the bracket 536. As shown in FIG. 33, the brackets 536 may be used to mount the bracket 504 to a pole, pipe, or other elongated support. The pole or pipe 537 may be disposed within the channels 577. A strap 538 (e.g., metal banding) may pass through the slots 529 to secure the pole or pipe 537 within the respective channels 577. Alternatively, the fifth holes 528 may be clearance holes to directly mount the bracket 504 to a surface (e.g., a wall or ceiling).

Returning to FIG. 31, the sixth holes 527 (e.g., central square holes) may be used for coupling the universal mounting bracket 504 to other accessories. As described in more detail below, this accessory may be an articulating mount 505 (see e.g., FIG. 25). The top surface 575 may also include pass-through slots 530 that can allow for the routing of cabling to pass from access points 425, antennas 430, devices, etc., to be consolidated to pass within the perimeter of the bracket 504.

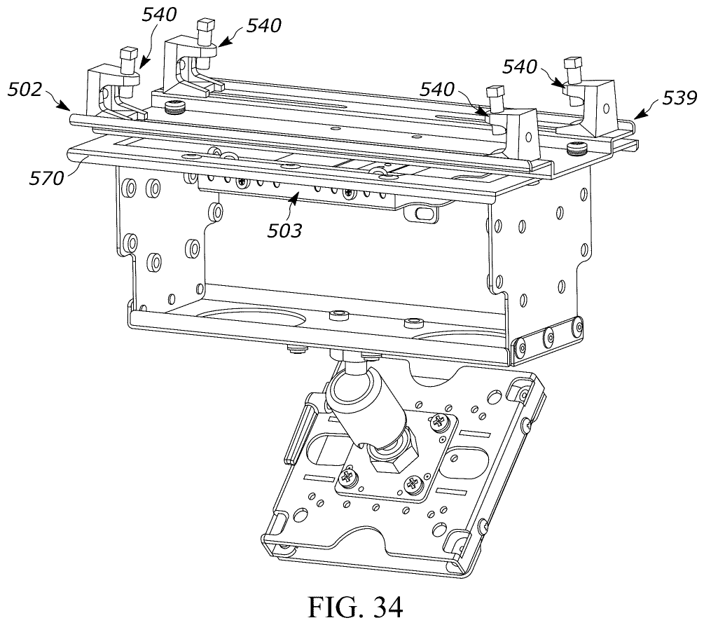

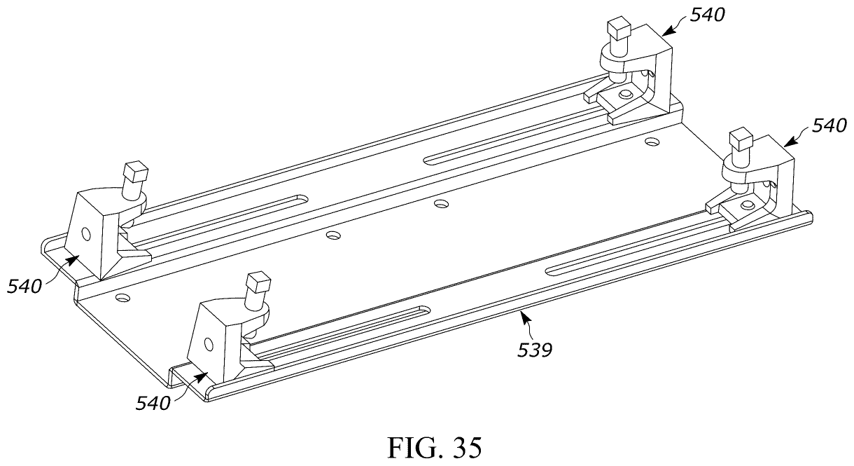

As shown in FIGS. 34 and 35, an accessory I-beam mounting bracket 539 is shown fastened to the top of the chassis assembly 502 via screws. The I-beam mounting bracket 539 contains I-beam clamps 540, that can slide in slots to accommodate varying I-beam widths. While the I-beam mounting bracket 539, is also capable of connecting to a universal mounting bracket 504, the use of the universal mounting bracket 504 is not necessary in this scenario as it can attach directly to the upper surface 570 of the chassis 502. In this case, the access point mounting bracket assembly 503 can attach via the flat flanges 512 of the chassis assembly 502.

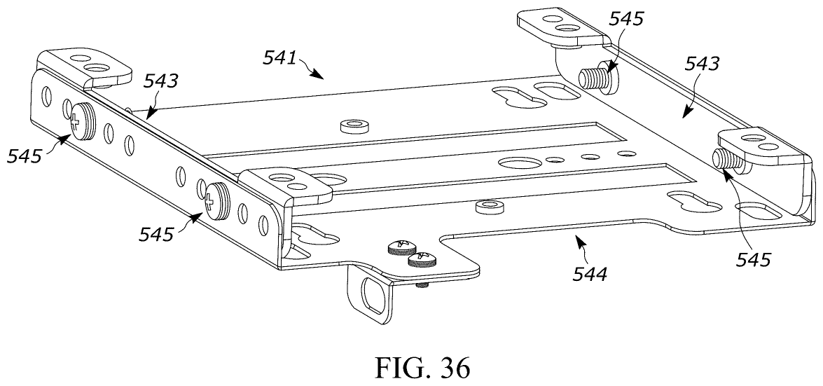

As shown in FIG. 36, an access point bracket assembly 541 that is designed to attach to the universal mounting bracket 504. The illustrated access point assembly bracket assembly 541 may be specifically designed for indoor use, but an outdoor use access point bracket assembly may be similarly used with the universal mounting bracket 504 and may have substantially the same shape as the illustrated indoor bracket 541. The access point bracket assembly 541 may include a pair of L brackets 543 and an access point mounting plate 544. In the illustrated example, the L brackets 543 may be separate from the access point mounting plate 544 and they may be coupled together with fasteners 545 (e.g., threaded screws). In other examples, one or more of the L brackets 543 may be integrally formed with the access point mounting plate 544.

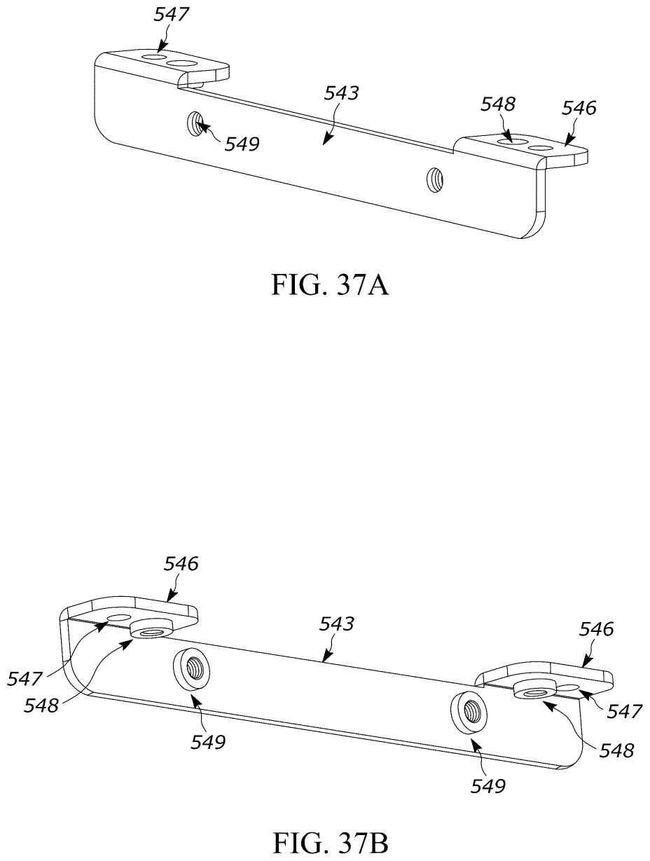

In some forms, the L brackets 543 may be designed to connect (e.g., thread) directly to the universal mounting bracket 504 via screws. As shown in FIGS. 37A and 37B, the L brackets 543 may have inward pointing flanges 546 (e.g., similar to flanges 531 on the universal mounting bracket 504). Each flange may have a clearance hole 547 and a PEM nut 548. The clearance holes 547 align with the PEM nuts 533 of the universal mounting bracket flanges 504. Similarly, the PEM nuts 548 may align with the clearance holes 532 of the flange 531 on the universal mounting bracket 504. As explained before, this gives the installer the convenience of choosing from which side of the bracket they can install the screw as it may vary in the particular scenario. In some cases, one side may be impossible to install the screw from, while access from the other side is needed. The side PEM nuts 549 allow for the attachments of the access point plate 544 with access to the screws located on the sides.

In some examples, the access point bracket assembly 541 may be a standalone component. The clearance holes 547 can be used can be used to mount the bracket assembly 541 against a wall, a backplate, or other support surface. Also, the assembled pair of the access point bracket assembly 541 and the universal mounting bracket assembly 504 can serve as standalone components outside of the colocation mount.

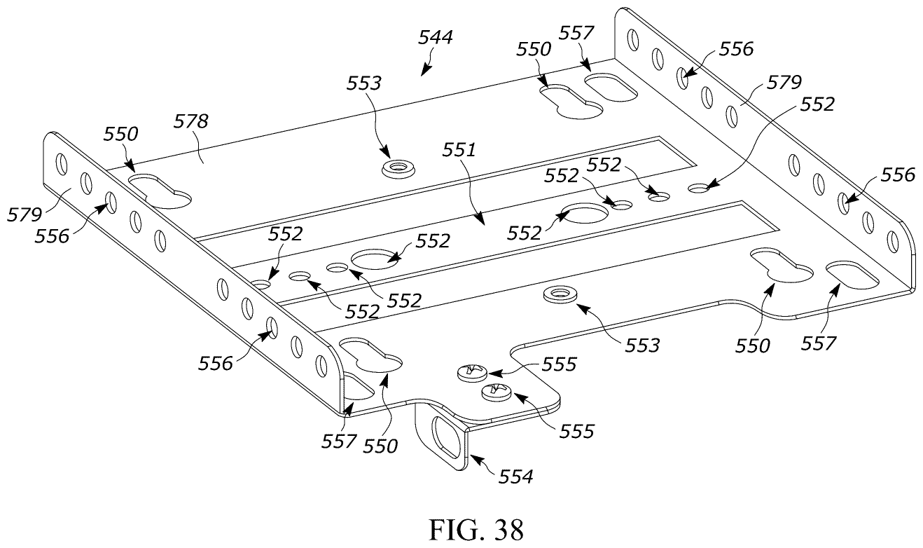

The access point mounting plate 544, shown in FIG. 38, can be used to directly connect to an access point 425 or other hardware. The access point mounting plate 544 may include a base 578 and a pair of side walls 579 that extend from the base 578. In the illustrated example, the side walls 579 may be integrally formed with the base 578, although in other examples, one or more of the side walls 579 may be connected to the base 578. The side walls 579 may be positioned on opposite ends of the base 578 and be oriented substantially perpendicularly with respect to the base 578.

In some forms, the base 578 may include keyholes 550, which may be sized and oriented to connect with certain brands or types of access points. The base 578 may also include a removable locking tab 554 that can be used with certain types of access points and can be attached via screws 555. A user can lock the access point to the bracket by inserting a cotter pin, zip tie, or other fastener through the tab's cutout. The tab 554, can be removed if used with other access points so that the access point mounting plate 544 may be substantially universal.

In some forms, material may be removed from the base 578 leaving a strip of material 551 in the center to serve as a simulated drop ceiling T-bar. The strip of material 551 may be between the keyholes 550, which may be arranged in a rectangular pattern around the strip of material 551. T-bar mounting is a very common method that most stock access points are capable of, so the strip of material 551 enables the access point mounting plate 544 to mount in this way. For example, holes 552 may be arranged on the strip of material 551 to connect to access points in this manner.

In some forms, the base 578 may include a pair of fastening members 553 (e.g., PEM nuts), which are spaced the same as a single gang junction box. That hole pattern is common among factory mounting brackets that come with access points, and so this arrangement of the fastening members 553 may permit that type of connection.

In some forms, the base 578 may include a cutout 557 disposed proximate to each of the keyholes 550. In the illustrated example, the keyholes 550 may be disposed between a pair of cutouts 557. Cutouts 557 may allow access to screws that insert into the L bracket clearance holes 547, and thread into the PEM nuts 533 of the universal mounting bracket 504.

Each of the side walls 579 may include clearance holes 556 through which fasteners 545 (e.g., screws) pass through to thread into the PEM nuts 549 of the L brackets 543. Only two clearance holes 556 per side wall 579 are needed to form the connection with the L brackets 543. However, each side wall 579 may include additional clearance holes 556 to permit the different connecting positions between the access point mounting plate 544 and the L brackets 543.

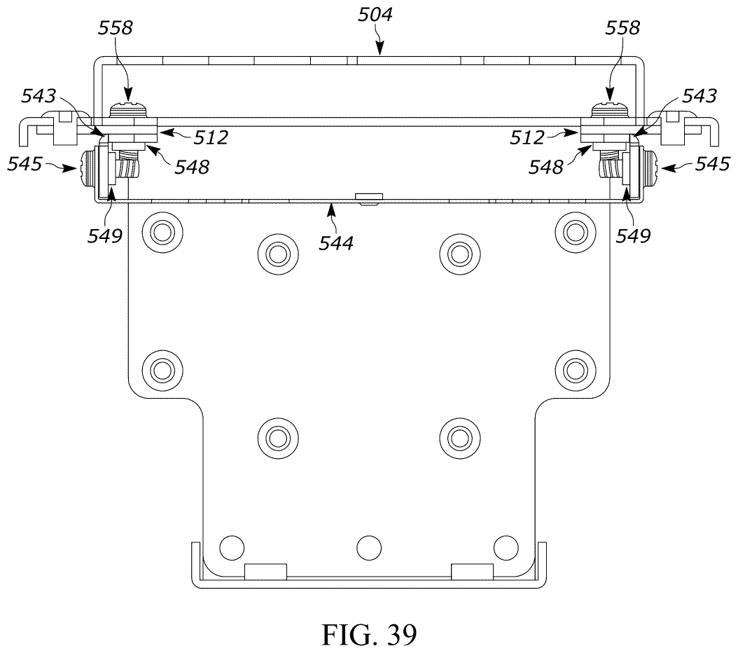

Returning to FIG. 25, the universal mounting bracket 504 and access point mounting bracket assembly 503 are shown installed. The sequence of assembly is that the universal mounting bracket 504 may be positioned on top of the flanges 512. Screws are installed in the universal mounting bracket's clearance holes 532, passing through corresponding the clearance holes 519 in the riveted flanges 512, and then thread into the PEM nuts 548 of the L brackets 543. The access point can be installed onto the access point mounting plate 544. Then the access point mounting plate 544 can installed to the side PEM nuts 549 of the L brackets 543 via screws 545. The cross section of these assembled parts is shown in FIG. 39.

In the case of installing the colocation mount against a flat wall or ceiling, the universal mounting bracket 504 does not need to be installed. The access point bracket assembly 541 is capable of being installed independently to the riveted flanges 512. An installer can mount the chassis assembly 502 by using fasteners in the corner holes 565.

With continued reference to FIG. 25, an articulating mount 505 may be attached to the bottom sides of the articulating mount tray 513 via screws that thread into PEM nuts 521. Though shown with a ball and socket joint articulating mount, any kind of articulating mount may be used. The ball and socket joint may allow for maximum adjustability and movement of the mount tray 513, which can help to accurately position an antenna. A lever 580 can lock the movement of the mount 505, which can be accomplished without additional tools.

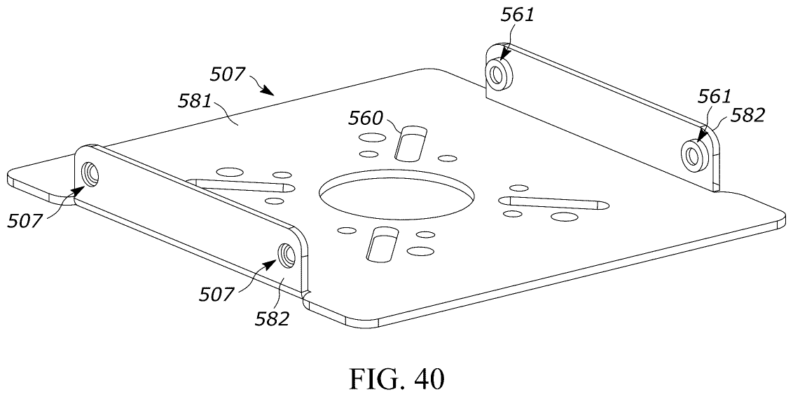

A universal mounting bracket 504 and an antenna bracket 507 may be connected to one another on the articulating mount 505. As illustrated in FIG. 40, antenna bracket 507 contains several hole patterns 560, which can accommodate the attachment of a variety of makes and models of antennas. The antenna bracket 507 may have a base 581 and a pair of upward bent flanges 582, which can contain fastening portions 561 (e.g., PEM nuts). The PEM nuts 561 may align with the side clearance holes 535 of the universal mounting bracket 504. The shape of the antenna bracket 507 may give it a low profile when joined with the universal mounting bracket 504.

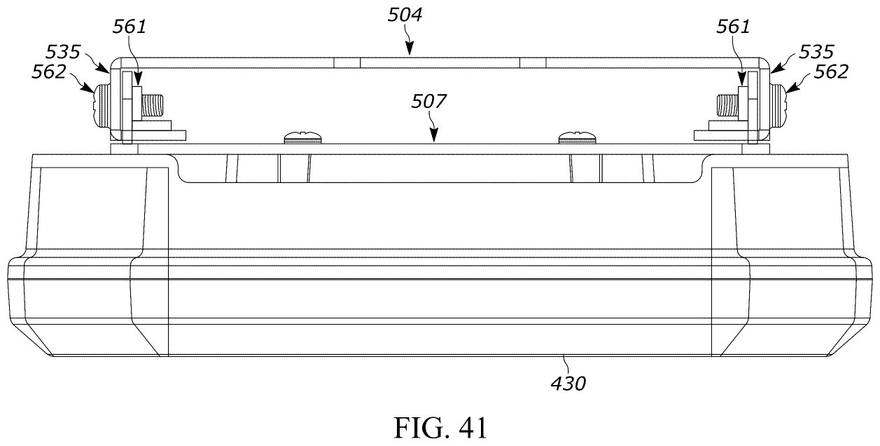

As shown in FIG. 41, the antenna bracket 507 is shown attached to both an antenna 430 and the universal mounting bracket 504. A set of screws 562 pass through the side clearance holes 535 of the universal mounting bracket 504 and thread into the side PEM nuts 561 located in the antenna bracket 507.

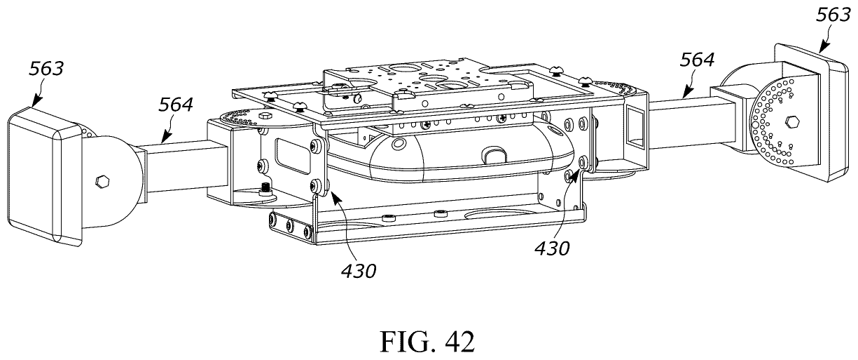

As shown in FIG. 42, additional antennas can be added to the PEM nuts 516 located on the sides of the colocation mount via articulating mounts 505, as well as articulating arms that can extend the antennas further away from the chassis assembly 502. For example, the colocation mount 500 may support with a pair of antennas 430 mounted on articulating arm mounts 564.

The mount 500 advantageously co-locates the antenna with the access point (radio). The antenna can be moved via the swivel joint such that it can be positioned to optimize its performance in conjunction with the radio. The mount is designed such that the cables from the antenna to the radio are hidden between the antenna and access point. This mount is also modular in nature, meaning components can be used independently or in different configurations with other components, enabling the mount 500 to be in many different scenarios. This helps make the mount 500 a universal mount because connecting the modular components in different configurations, the resulting mount assembly 500 can be used with antennas and/or access points having a variety of different shapes and sizes.

By using modular components, a colocation mount 500 can attach to common features found on deployment sites, such as walls, ceilings, I-beams, single and double gang junction boxes, poles, conduit, and all-thread. The modular brackets also accommodate mounting a wide variety of popular access points and antennas. Because of the modular architecture, antennas and access points can be easily upgraded, and many of the brackets can be used in applications outside of this specific design

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

What is claimed is:

1. A mounting assembly comprising:
a support bracket configured to couple to a support;
a mounting bracket coupled to the support bracket, the mounting bracket including,
a bar extending between a first end and a second end,
a first arm coupled between the first end and the mounting bracket,
a second arm coupled between the second end and the mounting bracket, and
a plate coupled to the bar and spaced apart from the first end and the second end; and
a clamping mechanism coupled to the support bracket, the clamping mechanism including,
a first rail including a first slot and a second slot,
a first clamp is movably coupled to the first rail via the second slot,
a second rail including a third slot and a fourth slot,
a second clamp is movably coupled to the second rail via the fourth slot;
wherein the bar is pivotable about a first axis relative to the first arm and the second arm;
wherein the plate is pivotable about a second axis relative to the bar and independent from the bar being pivotable about the first axis;
wherein the first rail is movably coupled to the second rail and is configured to move independent of the second rail;
wherein the first clamp is configured to move independently of the second clamp.

2. The mounting assembly of claim 1, further comprising a first frame connected between the first rail and the first clamp, wherein the first frame is configured to move relative to the second slot to adjust a height of the first clamp.

3. The mounting assembly of claim 1, wherein the first axis extends in a first direction and the second axis extends in a second direction substantially perpendicular to the first direction.

4. The mounting assembly of claim 1, further comprising a fastener that is received through the first slot and the third slot to coupled the first rail to the second rail, wherein the first rail is configured to translate about the fastener relative to the second rail.

5. The mounting assembly of claim 1, wherein the first rail is configured to move in a first direction and the second rail is configured to move in a second direction substantially perpendicular to the first direction.

6. The mounting assembly of claim 1, wherein the first rail is configured to move in a first direction and the second rail is configured to move in a second direction substantially parallel to the first direction.

7. A method of mounting WiFi access hardware, the method comprising:
moving a first rail to a first position and a second rail to a second position to form a mounting space;
positioning the WiFi access hardware within the mounting space;
moving a first clamp relative to the first rail, wherein the first clamp is configured to contact a surface of the WiFi access hardware; and
moving a second clamp relative to the second rail, wherein the second clamp is configured to contact the surface of the WiFi access hardware;
wherein the first clamp is movable independently of the second clamp.

8. The method of claim 7, wherein the first rail includes a first slot and the second rail includes a second slot, and wherein a common fastener is inserted through the first slot and the second slot.

9. The method of claim 7, wherein the first rail is movable independently of the second rail.

10. The method of claim 7, further comprising a first frame connected between the first clamp and the first rail, wherein the first frame is translatable relative to the first rail, and wherein the first frame is fixed relative to the first clamp.

11. A mounting assembly for mounting wireless communication hardware comprising:
a main chassis assembly including,
a chassis base,
a pair of chassis flanges extending from the chassis base, and
a tray connected to the pair of chassis flanges and oriented parallel to the chassis base;
an access point mounting assembly connected to a first side of the chassis base between the pair of chassis flanges;
a wireless access point connected to the access point mounting assembly between the pair of chassis flanges; and
a universal mounting bracket connected to a second side of the chassis base opposite to the access point mounting assembly, wherein the universal mounting bracket includes a first set of mounting openings sized to connect to a first electrical box and a second set of mounting openings sized to connect to a second electrical box.

12. The mounting assembly of claim 11, wherein the access point mounting assembly includes an access point mounting plate and an L bracket coupled to the access point mounting plate, wherein the L bracket includes an L bracket flange with a first mounting opening and a second mounting opening, and wherein the first mounting opening and/or the second mounting opening are configured to receive a fastener to couple the access point mounting assembly to the universal mounting bracket.

13. The mounting assembly of claim 12, wherein the access point mounting plate includes a base surface that has a central section, a left section separated from the central section by a first cutout, and a right section separated from the central section by a second cutout, and wherein the central section is configured to facilitate T-bar mounting.

14. The mounting assembly of claim 13, wherein the left section includes a pair of elongated openings and a pair of keyhole openings, wherein the pair of keyhole openings are disposed between the pair of elongated openings, and wherein a fastener is inserted through the pair of elongated openings and/or the pair of keyhole openings to engage the wireless access point.

15. The mounting assembly of claim 11, further comprising a pipe mounting bracket connected to the universal mounting bracket via a third set of mounting openings, wherein a slot is disposed on the universal mounting bracket between the third set of mounting openings, and wherein the pipe mounting bracket is configured to connect the mounting assembly to a cylindrical support and the slot is configured to receive a strap for securing the cylindrical support to the pipe mounting bracket.

16. The mounting assembly of claim 11, wherein the universal mounting bracket includes a bracket base, a side flange extending from the bracket base, and a connecting flange extending from the side flange parallel to the bracket base.

17. The mounting assembly of claim 11, wherein the universal mounting bracket is a first universal mounting bracket, the mounting assembly further comprising,
a second universal mounting bracket coupled to the trap;
an antenna bracket coupled to the second universal mounting bracket; and
an antenna coupled to the antenna bracket;
wherein the wireless access point and the antenna are collocated on the mounting assembly.

18. The mounting assembly of claim 17, further comprising an articulating mount coupled between the second universal mounting bracket and the tray, wherein the articulating mount includes a ball and socket joint.

19. The mounting assembly of claim 17, wherein antenna bracket includes an antenna bracket base with a set of attachment apertures configured to facilitate connection with the antenna, and an antenna bracket flange oriented perpendicular to the antenna bracket base, wherein the antenna bracket flange is coupled to the second universal mounting bracket.

20. The mounting assembly of claim 17, wherein the first universal mounting bracket is identical to the second universal mounting bracket.
